(19) United States
(12) Patent Application Publication
(10) Pub. No.: US 2004/0019635 A1
(43) Pub. Date: Jan. 29, 2004

(54) Using a document identifier for document retrieval and printing

(76) Inventors: Samuel M. Lester, Boise, ID (US); Jimmy Sfaelos, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/205,980

(22) Filed: Jul. 25, 2002

(51) Int. Cl. G06F 15/16

(52) U.S. Cl. 709/203

(57) ABSTRACT

A document identifier is received from a portable device and the document is retrieved from one or more network servers identified by the document identifier. The document is then transferred to the printer for printing the document.

### TECHNICAL FIELD

This invention relates generally to printing devices, and more particularly to the use of a document identifier for document retrieval and printing.

### BACKGROUND

Computer technology is continually advancing, resulting in increasingly powerful computing devices. These advances have similarly led to the creation of new types of portable devices with computer-type functionality, such as cellular telephones and handheld or pocket computers or organizers. An additional result from these advances is the development of networking technology that allows various computing devices to communicate with one another. One common network is the Internet, which allows a large amount of information to be made available around-the-clock to a large number of computing devices.

The combination of these smaller portable devices and networks, however, has created some problems. One such problem is that these portable devices tend to have smaller amounts of memory and much smaller displays than larger (e.g., desktop) computers. Thus, data which can be easily handled by a desktop computer cannot be easily handled by a small portable device. For example, a user of a portable device may desire to access, from a network server on a network, a document containing a large amount of graphical images and/or a large number of pages, and print out the document to a printer. The limited display and memory capabilities of the portable device, however, make such retrieval and printing difficult at best (if even possible at all).

One solution to this problem is for the portable device to communicate an identifier of the document directly to the printer and have the printer retrieve the document from the server over the network. However, this solution has problems as well because it requires the printer to have the ability to understand such requests from portable devices as well as the ability to retrieve the document from the server. Many existing printers do not have such abilities, nor are they designed to be easily modified to add such abilities. New printers could be purchased which include such abilities, but this is an expense that many users will not want to incur. Thus, it would be beneficial to improve the way in which portable devices can communicate document identifiers for printing.

The communication of a document identifier to a computing device for document retrieval and printing as described herein helps solve these problems.

### SUMMARY

Using a document identifier for document retrieval and printing is described herein.

According to one aspect, a document identifier is received from a portable device. The document is then retrieved from one or more network servers identified by the document identifier. The document is then transferred to the printer for printing the document.

### BRIEF DESCRIPTION OF THE DRAWINGS

FIG. 1 illustrates an exemplary environment in which the communicating of a document identifier to a computing device for document retrieval and printing can be employed.

FIG. 2 illustrates the environment of FIG. 1 in additional detail.

FIG. 3 is a flowchart illustrating an exemplary process for communicating a document identifier to a computing device for document retrieval and printing.

FIG. 4 illustrates portions of an exemplary device in additional detail.

### DETAILED DESCRIPTION

Communicating a document identifier to a computing device for document retrieval and printing is described herein. A portable device communicates an identifier of a document to be printed to a computing device. The computing device, in turn, obtains the document from its source(s) and sends the document to a printer for printing. By communicating the identifier to the computing device rather than to the printer, the printer is alleviated of the burden of receiving the communication from the portable device as well as the burden of obtaining the document from its source(s). Additionally, the portable device is alleviated of the burden of having to obtain the document to be printed.

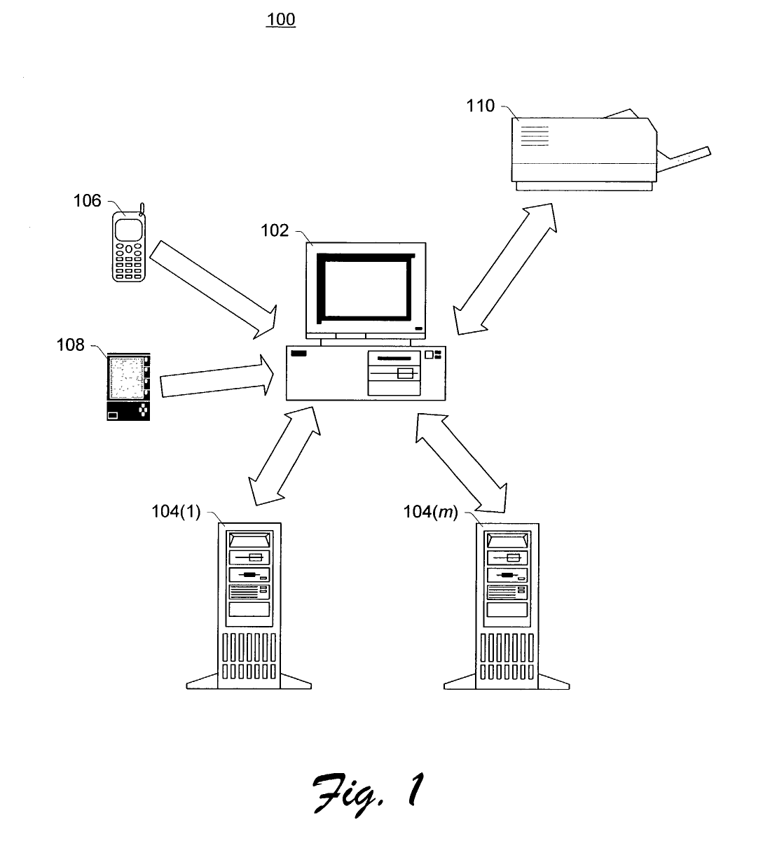

FIG. 1 illustrates an exemplary environment 100 in which the communicating of a document identifier to a computing device for document retrieval and printing can be employed. In environment 100, a computer or computing device 102 is coupled to one or more servers 104(1), . . . , 104(m), portable devices 106 and 108, and a printing device 110. Computing device 102 can be coupled to printer 110 directly (e.g., via a parallel port connection, a Universal Serial Bus (USB) connection, a firewire connection, etc.), or indirectly (e.g., via a network, such as a local area network (LAN)). Servers 104 are typically coupled to computing device 102 via a network, but alternatively may be coupled directly to computing device 102. The network(s) used to couple computing device 102 to servers 104 and/or printing device 110 can be any of a wide variety of conventional network topologies and types (including wired and/or wireless networks), employing any of a wide variety of conventional network protocols (including public and/or proprietary protocols). In one implementation, the network used to coupled computing device 102 to network servers 104 includes the Internet (and may include one or more LANs), allowing device 102 and servers 104 to communicate via TCP/IP (Transmission Control Protocol/Internet Protocol) and HTTP (HyperText Transport Protocol).

Computing device 102 can be any of a wide variety of conventional computing devices, including a desktop PC, a workstation, an Internet appliance, a gaming console, or the like. Although only one computing device is illustrated in FIG. 1, portable devices 106 and 108 can communicate with different computing devices 102, which can be the same types of devices or alternatively different types of devices.

Printing device 110 can be any of a wide variety of conventional devices capable of generating a hard copy of data received from a computing device. Examples of printing devices include printers, facsimile machines, multi-function machines (e.g., capable of performing multiple functions, such as the functions of both a printer and a facsimile machine). Printing device 110 can generate hard copies of data in any of a variety of manners, such as by using toner (e.g., in laser printers), ink (e.g., in inkjet printers, bubblejet printers, dot matrix printers, etc.), heat applied to heat-sensitive print media (e.g., thermal printers), and so forth.

Portable devices 106 and 108 represent any of a wide variety of portable devices capable of communicating a document identifier (e.g., a Uniform Resource Locator (URL)) to a computing device. Devices 106 and 108 are referred to as “portable” because they are typically smaller and lighter than traditional desktop computers. Examples of portable devices 106 and 108 include cellular telephones, handheld or pocket PCs, personal digital assistants (PDAs), multi-function devices (e.g., combining the functionality of a PDA and a cellular telephone), wearable computers, and so forth. Portable devices 106 and 108 typically include a processor or controller and memory (volatile and/or nonvolatile), and thus are also referred to as computing devices. Portable devices 106 and 108 may also take other forms such as watches or other types of jewelry, smartcards, pens or pencils, still or moving image capture devices (e.g., digital cameras), and so forth.

In environment 100, a user of one of portable devices 106 or 108 can communicate an identifier, such as a URL, of a document to computing device 102. Computing device 102, upon receiving a request to do so from portable device 106 or 108 (e.g., upon receipt of the URL from device 106 or 108), obtains the document from its source. The identifier includes a location where the document can be found, such as a particular one of servers 104. Computing device 102 retrieves the document from the appropriate server(s) 104 and communicates with printer 110 to have the document printed on printer 110. The user of one of portable devices 106 or 108 is thus able to have documents printed at printer 110 even though the document is not stored on device 106 or 108, and even though printer 110 need have no knowledge that the printing request originated with the portable device 106 or 108.

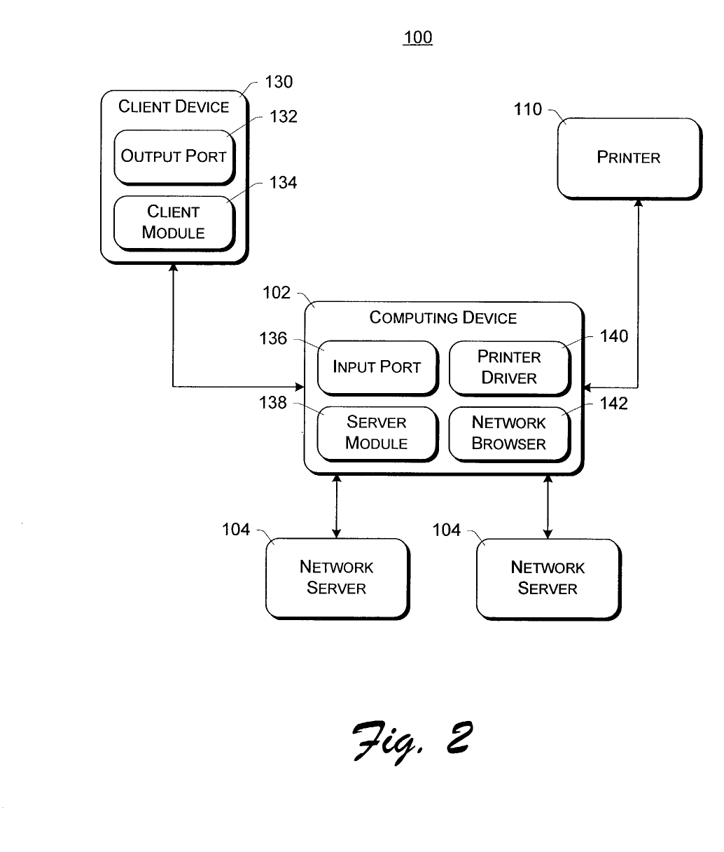

FIG. 2 illustrates the environment 100 in additional detail. Client device 130 is a portable device (e.g., one of devices 106 or 108 of FIG. 1) and includes both an output port 132 and a client module 134. Client device 130 may also include any of a variety of additional conventional components, such as keypads or other input mechanisms, a controller or processor, a display mechanism (e.g., LCD screen), etc., however these additional components have not been shown in FIG. 2 so as to avoid cluttering the drawings.

Portable client device 130 is typically located nearby or in close physical proximity to computing device 102. How close portable client device 130 needs to be to computing device 102 can vary based on the wireless connection and the manner in which the connection is implemented. Portable client device 130 and computing device 102 should be close enough to one another that data can be communicated between the two wirelessly. For example, if client devices 130 and 102 are communicating via an infrared (IR) connection then the devices typically need to be closer to one another than if they were communicating via a radio frequency (RF) connection.

Computing device 102 includes an input port 136, a server module 138, a printer driver 140, and a network browser 142. Computing device 102 also includes additional conventional components, however these additional components have not been shown so as to avoid cluttering the drawings.

Client module 134 of client device 130 communicates a document identifier(s) to server module 138 of computing device 102 via output port 132 of client device 130 and input port 136 of computing device 102. This communication from client device 130 to computing device 102 is also referred to as “squirting” the identifier to computing device 102. In the illustrated example, port 132 is for output and port 136 is for input. In alternate embodiments where communication from server module 138 to client module 134 is desired (e.g., for communicating print setting options to device 130, as discussed in more detail below), an input port is included on client device 130 (e.g., port 132 may be an input/output port, or a separate input port may be included) and an output port is included on computing device 102 (e.g., port 136 may be an input/output port, or a separate output port may be included).

The document identifier that client module 134 communicates to server module 138 can be obtained by client module 134 in any of a variety of manners. For example, the user of client device 130 may input the identifier via an input device (e.g., keypad) of client device 130. By way of another example, multiple identifiers may be stored in a memory component of client device 130 and the user of client device 130 may select from those stored identifiers. By way of yet another example, another device may communicate the identifier to client device 130 (via a wired or wireless transfer).

Output port 132 communicates with input port 136 via a wireless connection. This wireless connection may be, for example, an IR frequency connection (e.g., in accordance with IrDA specifications available from The Infrared Data Association of Walnut Creek, Calif.), an RF connection (e.g., in accordance with IEEE 802.11 specifications available from the Institute of Electrical and Electronics Engineers or in accordance with the Bluetooth specifications available from the Bluetooth SIG, Inc. at bluetooth.com), etc.

Upon receipt of the identifier (or alternatively, upon receipt of a “retrieve and print” command from client module 134), server module 138 communicates the identifier to network browser 142, which in turn accesses one or more servers 104, as indicated by the identifier, in order to retrieve the identified document. Network browser 142 can be a proprietary browser, or alternatively may be any of a variety of conventional publicly available network browsers. In one implementation, network browser 142 is the Internet Explorer browser available from Microsoft Corporation of Redmond, Wash. Alternatively, network browsing functionality may be incorporated into server module 138, so server module 138 may retrieve the identified document from the servers 104 rather than network browser 142.

The identifier includes a location where the document can be found, such as a particular one of servers 104. The identifier also includes an indication of which of multiple documents on a server the identifier corresponds to. For example, a server 104 may have multiple documents stored in a directory tree structure, and the identifier may include an indication of where in that directory tree structure the document is stored (alternatively, the identifier may not include such an indication, but rather rely on server 104 to know (e.g., based on the name of the document as indicated in the document identifier) where the document is stored in the directory tree structure).

The content of a document to be retrieved may be stored on a single server or alternatively multiple servers. If various portions of a document are stored on multiple servers 104, network browser 142 retrieves the various portions from the appropriate servers 104. It should be noted that although the discussions herein refer to retrieving the document (or a portion of a document) from a server, there may be additional document sources, such as one or more intermediary devices or caches from which the document is actually obtained. For example, a cache (not shown) may be situated between computing device 102 and a network server 104, and when the cache receives the request for the document the cache will return the document to computing device 102 (assuming the cache has a valid copy of the document) rather than burdening network server 104 with the request. By way of another example, computing device 102 may include a local cache from which documents are retrieved.

A document can be made up of virtually any type of data, such as video frames, graphical images, text, drawings, combinations thereof, etc. Additionally, a document may also include non-printable data (e.g., audio data), although such data would not be printed by printer 110. A document may be contained within a single file, or alternatively may identify one or more other files or documents that are to be retrieved in order to print the entire document. For example, a HyperText Markup Language (HTML) document may include links to other documents that make up part of the HTML document, such as links to images (e.g., “.gif” or “.bmp” files) that are to be retrieved and displayed/printed as part of the document.

Once the document is retrieved, server module 138 communicates a print request to network browser 142 to print the document, which in turn invokes printer driver 140 to communicate a print request to printer 110. Alternatively, server module 138 may communicate a request to print the document prior to the document being retrieved, optionally informing browser 142 to wait to print the document until the entire document has been retrieved. The document may be converted into a print-ready language (a language understood by the print engine of printer 110) version of the document by printer driver 140, or alternatively this conversion may be performed by printer 110. The print-ready language or format used can vary based on the type of printer and the manufacturer of the printer. An example of such a print-ready language is PCL (Printer Control Language).

Printer 110 receives the print request and generates a hard copy of the desired data. To printer 110, the print request is just like any other print request received from computing device 102—printer 110 need have no knowledge (and typically does not have any knowledge) that the desired document was identified by client device 130. Printer 110 can thus be any conventional printing device.

In the illustrated example, portable client device 130 squirts a document identifier to computing device 102, which in turn retrieves and prints the identified document. Various conventional print settings may be used by printer 110 in printing the document, such as number of copies, print quality, paper size, duplex printing on or off, and so forth. These print settings may be default values or alternatively may be received from portable client device 130. Print settings received from client device 130 may be embedded in the document identifier or alternatively communicated separately. These print settings are then communicated to printer driver 140 and used by printer driver 140 in preparing the print-ready version of the document for printer 110 for printing or communicated to printer 110 for printing.

Alternatively, server module 138 may communicate one or more print setting options to client module 134. These print setting options can be rendered to the user of portable client device 130, and user selections of these options can be received at portable client device 130. Thus, the user is able to select, for each document identifier squirted to computing device 102, the print settings to be used in printing the document. These print setting selections are then communicated by client module 134 to server module 138, and then to printer driver 140 and printer 110 to be used in printing the document.

In one exemplary implementation, network servers 104 are world wide web (or just “web”) servers coupled to computing device 102 via the Internet. Computing device 102 can retrieve documents from the web servers by communicating a URL identifying the documents via HTTP to the appropriate server(s).

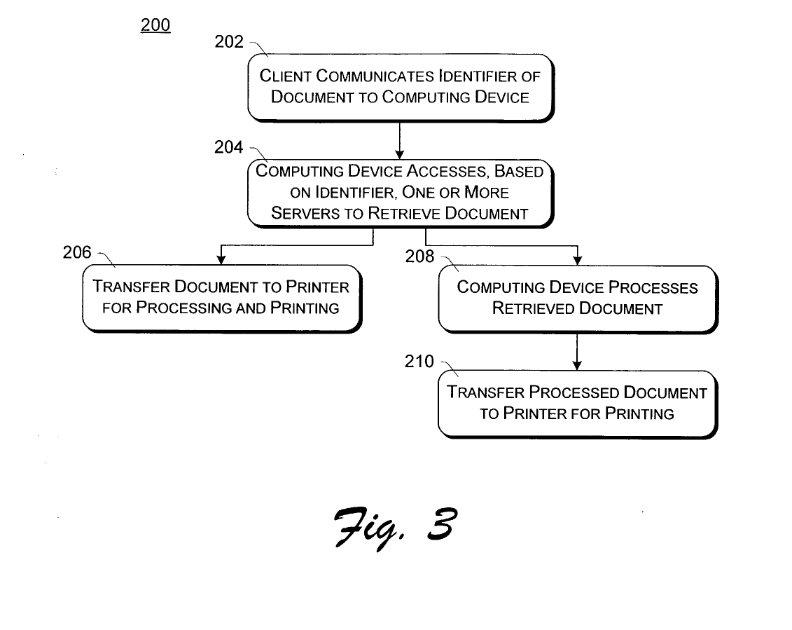

FIG. 3 is a flowchart illustrating an exemplary process 200 for communicating a document identifier to a computing device for document retrieval and printing. Process 200 may be performed in software, firmware, hardware, or combinations thereof. Initially, a client (e.g., a portable device of FIG. 1 or 2) communicates the identifier of a document to the computing device (act 202). The computing device accesses, based on the identifier, one or more servers to retrieve the identified document (act 204). The computing device may be configured to then perform one of two actions. The computing device may transfer the document to the printer for processing (converting to a print-ready format) and printing (act 206). Alternatively, the computing device may process (convert to a print-ready format) the retrieved document itself (act 208) and then transfer the processed document to the printer for printing (act 210).

Thus, it can be seen that the user of a portable device can communicate (squirt) one or more document identifiers to a computing device and have that computing device retrieve the identified document(s) from remote sources and have the identified document(s) printed. The portable device thus need not store the content of the identified document(s), but only the identifier(s) of the document(s). Additionally, the printer need have no knowledge that the portable device is the source of the document identifier(s) and need perform no special processing in order to retrieve the identified document(s). Any of a wide variety of currently available and legacy printers (e.g., pre-existing printers, discontinued printer models, etc.) that do not have the ability to retrieve documents from a remote source nor the ability to be upgraded (or easily upgraded) to include that ability can be used to print the identified document(s).

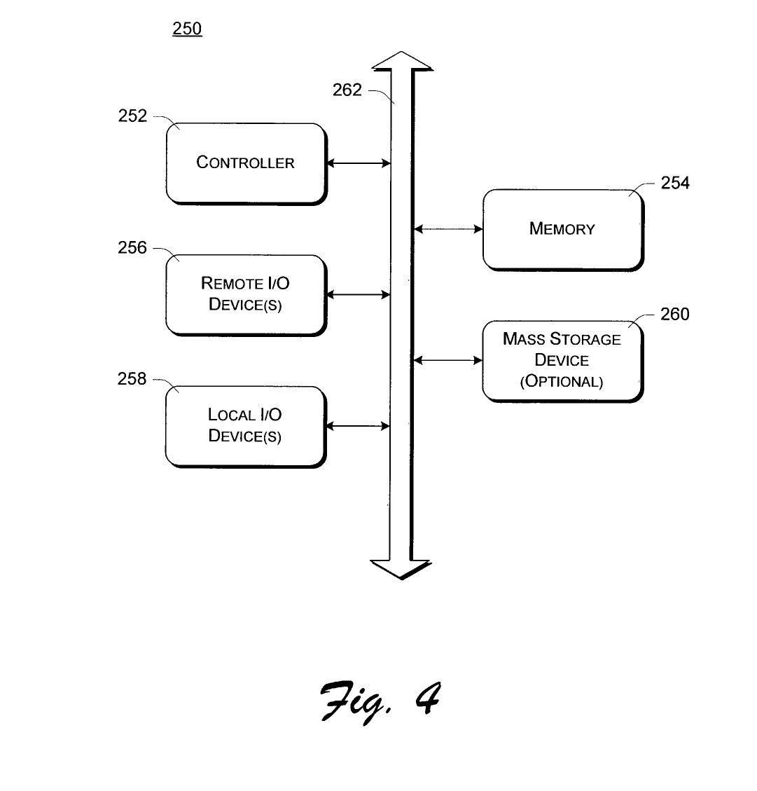

FIG. 4 illustrates portions of an exemplary device 250 in additional detail. Device 250 can be, for example, a computing device 102, portable device 106 or 108, or server 104 of FIG. 1, or device 102 or 130, or server 104 of FIG. 2. Device 250 includes a processor or controller 252, a memory 254, a remote I/O device(s) 256, a local I/O device(s) 258, and an optional mass storage device 260, all coupled to a bus 262. Depending on the type of the device, various additional conventional components may also be typically included in device 250.

Controller or processor 252 can be a general purpose microprocessor or a dedicated microcontroller (e.g., one or more Application Specific Integrated Circuits (ASICs) or programmable logic devices (PLDs)). Remote I/O device(s) 256 is one or more conventional interface devices allowing components of device 250 (e.g., controller 252) to communicate with other devices external to device 250. Remote I/O device(s) 256 may include, for example, a modem, a network interface card (NIC), a parallel port, a serial port, a universal serial bus (USB) port, and so forth. Local I/O device(s) 258 is an interface device allowing local commands and/or data to be input to and/or output from device 250. Local I/O device(s) 258 may include, for example, a display device (e.g., liquid crystal display (LCD), light emitting diode (LED), etc.), a keypad (e.g., alphanumeric or otherwise), a touchscreen, a cursor control device (e.g., a trackpad, trackball, etc.), print media handlers and printing components (e.g., ink or toner dispensers), and so forth.

Bus 262 represents one or more buses in printing device 250, which may be implemented in accordance with public and/or proprietary protocols. The bus architecture can vary by printing device as well as by manufacturer. Mass storage device 260 is optional and represents any of a wide variety of conventional storage devices, such as fixed or removable magnetic or optical disks, Flash memory, and the like.

Memory 254 represents volatile and/or nonvolatile memory used to store instructions and data for use by controller or processor 252. Typically, instructions are stored on a mass storage device 260 (or nonvolatile memory portion of memory 254) and loaded into a volatile memory portion of memory 254 for execution by controller or processor 252. Additional memory components may also be involved, such as cache memories internal or external to controller or processor 252. Various embodiments of the invention may be implemented, at different times, in any of a variety of computer readable media that is part of, or readable by, device 250. For example, such computer readable media may be mass storage device 260, memory 254, a cache memory, media (e.g., a magnetic or optical disk) accessible to device 250, and so forth.

Device 250 is exemplary only. It is to be appreciated that additional components (not shown) can be included in device 250 and some components illustrated in device 250 need not be included. For example, additional processors or storage devices, additional I/O interfaces, and so forth may be included in device 250, or mass storage device 260 may not be included.

Various discussions herein refer to components and modules that can be implemented in a computing device. It is to be appreciated that the components and processes described herein can be implemented in software, firmware, hardware, or combinations thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary embodiments of the invention.

1. A method comprising:
receiving, from a portable device, a document identifier;
retrieving the document identified by the document identifier; and
transferring the document to a printer for printing the document.

2. A method as recited in claim 1, wherein the retrieving comprises retrieving each of different portions of the document from different network servers.

3. A method as recited in claim 1, further comprising:
communicating one or more print setting options to the portable device;
receiving, from the portable device, an indication of one or more print setting selections; and
communicating the one or more print setting selections to the printer.

4. A method as recited in claim 1, wherein the document identifier comprises a Uniform Resource Locator (URL).

5. A method as recited in claim 1, wherein the retrieving comprises retrieving the document from one or more world wide web servers.

6. One or more computer readable media having stored thereon a plurality of instructions that, when executed by one or more processors of a computer, causes the one or more processors to:
receive, from a client device, a Uniform Resource Locator (URL);
retrieve, from a network server identified by the URL, a document identified by the URL; and
transfer the document to a printer for printing the document.

7. One or more computer readable media as recited in claim 6, wherein the instructions further cause the one or more processors to process the retrieved document to generate a version of the document in a print-ready language, and wherein the one or more instructions that cause the one or more processors to transfer the document comprise one or more instructions that cause the one or more processors to transfer the version of the document in the print-ready language to the printer for printing of the document.

8. One or more computer readable media as recited in claim 6, wherein the one or more instructions that cause one or more processors to retrieve the document comprise one or more instructions that cause the one or more processors to retrieve each of different portions of the document from different network servers.

9. One or more computer readable media as recited in claim 6, wherein the one or more instructions that cause the one or more processors to transfer the document to the printer for printing the document comprise one or more instructions that cause the one or more processors to transfer the document to the printer for printing the document using a plurality of print setting values.

10. One or more computer readable media as recited in claim 6, wherein the instructions further cause the one or more processors to:
communicate one or more print setting options to the client device;
receive, from the client device, an indication of one or more print setting selections; and
communicate the one or more print setting selections to the printer to be used in printing the document.

11. One or more computer readable media as recited in claim 10, wherein the one or more print setting selections are user selections.

12. One or more computer readable media as recited in claim 6, wherein the one or more instructions that cause the one or more processors to receive the URL comprise one or more instructions that cause the one or more processors to receive, with the URL, an indication of one or more print settings to be used in printing the document.

13. One or more computer readable media as recited in claim 6, wherein the one or more instructions that cause the one or more processors to receive the URL cause the one or more processors to receive the URL via an Infrared (IR) port.

14. One or more computer readable media having stored thereon a plurality of instructions that, when executed by one or more processors of a computer, causes the one or more processors to:
receive, from a portable device, a document identifier;
have the document identified by the document identifier retrieved; and
have the document communicated to a printer to generate a hard copy of the document.

15. One or more computer readable media as recited in claim 14, wherein the instructions that cause the one or more processors to have the document identified by the document identifier retrieved comprise instructions that cause the one or more processors to have the document identified by the document identifier retrieved from a web server identified by the document identifier.

16. One or more computer readable media as recited in claim 14, wherein the instructions further cause the one or more processors to:
communicate one or more print setting options to the portable device;
receive, from the portable device, an indication of one or more print setting selections; and
communicate the one or more print setting selections to a printer driver of the computer.

17. A system comprising:
a computing device configured to,
receive, from a portable device, a document identifier,
retrieve the document identified by the document identifier from one or more network servers, and
transfer the document to a printer for printing the document; and
wherein the printer is coupled to receive the document from the computing device and configured to print the document without knowledge that the document identifier was received by the computing device from the portable device.

18. A system as recited in claim 17, wherein the portable device is configured to communicate the document identifier to the computing device, and further configured to communicate one or more print settings to the computing device.

19. A system as recited in claim 17, wherein the document identifier comprises a Uniform Resource Locator (URL).

20. A system as recited in claim 17, wherein each of the one or more network servers comprises a world wide web server.

21. One or more computer readable media having stored thereon a plurality of instructions that, when executed by one or more processors of a computer, causes the one or more processors to:
communicate, via a wireless connection, with a client device;
receive, via the wireless connection, a Uniform Resource Locator (URL);
have a document retrieved from a network server over the Internet, wherein both the document and the network server are identified by the URL; and
have the document communicated to a printer coupled to the computer to generate a hard copy of the document.

22. One or more computer readable media as recited in claim 21, wherein the instructions further cause the one or more processors to:
communicate one or more print setting options to the client device;
receive, from the client device, an indication of one or more print setting selections; and
communicate the one or more print setting selections to the printer.

23. One or more computer readable media having stored thereon a plurality of instructions that, when executed by one or more processors of a client device, causes the one or more processors to:
communicate, to a computing device, a document identifier; and
have the computing device retrieve the identified document and communicate the document to a printer for printing of the document.

24. One or more computer readable media as recited in claim 23, wherein the plurality of instructions further causes the one or more processors to:
communicate, to the computing device, one or more print settings to be used in printing the document.

25. One or more computer readable media as recited in claim 23, wherein the plurality of instructions further causes the one or more processors to:
display one or more print settings for the document;
receive user selections of one or more of the print settings; and
communicate, to the computing device, the user selections.

26. One or more computer readable media as recited in claim 23, wherein the document identifier comprises a Uniform Resource Locator (URL).

27. A method, implemented in a portable device, the method comprising:
communicating, to a computing device, a document identifier; and
having the computing device retrieve the identified document from one or more document sources and transfer the document to a printer for printing.

28. A method as recited in claim 27, wherein the document identifier comprises a Uniform Resource Locator (URL).

29. A method as recited in claim 27, further comprising:
displaying one or more print settings for the document;
receiving user selections of one or more of the print settings; and
communicating, to the computing device, the user selections.
